(19) United States
(12) Patent Application Publication
(10) Pub. No.: US 2026/0049893 A1
(43) Pub. Date: Feb. 19, 2026

(54) OPTICAL ELEMENT, LENS APPARATUS, IMAGE PICKUP APPARATUS, AND METHOD FOR IDENTIFYING OPTICAL ELEMENT

(71) Applicant: CANON KABUSHIKI KAISHA, Tokyo (JP)

(72) Inventors: MICHIO ENDO, Tochigi (JP); YUUICHI TAKAIE, Tochigi (JP)

(21) Appl. No.: 19/296,638

(22) Filed: Aug. 11, 2025

(30) Foreign Application Priority Data
Aug. 13, 2024 (JP) 2024-134902

(51) Int. Cl. G01M 11/02; G02B 27/00; H04N 23/55

(52) U.S. Cl. CPC G01M 11/025; G02B 27/0012; H04N 23/55

(57) ABSTRACT

An optical element includes a region that satisfies, an inequality of 50 nm≤|PV|≤1000 nm, where PV represents a PV value which is a difference between a maximum value and a minimum value of Δf(θ) which is obtained by removing a 1-fold symmetric component and a 2-fold symmetric component about an optical axis from f(θ), where f(θ) represents a position of an optical surface in an optical axis direction on a circumference at a first radius of 60% or more and 100% or less of an optically effective diameter with respect to a position θ in a rotation direction about the optical axis.

### BACKGROUND

### Field of the Technology

The aspect of the embodiments relates to an optical element, a lens apparatus, an image apparatus, and a method for identifying an optical element.

### Description of the Related Art

Since an optical element, particularly an aspherical glass lens, does not have a mark serving as a singular point even when a shape of a molding surface of a lens obtained by press-molding a glass material is observed, the optical element cannot be identified, and it is difficult to track or manage a manufacturing history.

Japanese Patent Laid-Open No. 2006-268015 discloses a marking method in which an optical defect such as a convex portion, a concave portion, a colored portion, a portion having a different refractive index, a bubble embedded in an optical element, or a fine particle embedded in the optical element is used as a management marker in an effective optical surface of the optical element.

Japanese Patent Laid-Open No. 2006-293115 discloses an identification method in which one optical surface of one side of an optical element is provided with an identification means based on a convex portion or roughness due to transfer of a shape of a mold.

In Japanese Patent Laid-Open No. 2006-268015, to facilitate the above-described management, the marker needs to have a size (10 μm or larger and 200 μm or smaller) that can be identified by an optical microscope. However, when a marker having such a size is in the effective optical surface, incident beams are scattered and reflected by the marker portion, and the imaging performance deteriorates, and there is a problem in that the marker cannot be applied to a product requiring high resolution.

In Japanese Patent Laid-Open No. 2006-293115, since the identification means transfers irregularities and roughness having a certain position and size formed on the mold, when manufacturing conditions are changed in a lot, it is necessary to prepare and replace the mold corresponding to each condition.

### SUMMARY

The optical element includes a region that satisfies a following inequality,

50 nm≤|PV|≤1000 nm

where PV represents a PV value which is a difference between a maximum value and a minimum value of Δf(θ) which is obtained by removing a 1-fold symmetric component and a 2-fold symmetric component about an optical axis from f(θ), where f(θ) represents a position of an optical surface in an optical axis direction on a circumference at a first radius of 60% or more and 100% or less of an optically effective diameter with respect to a position θ in a rotation direction about the optical axis.

Features of the disclosure will become apparent from the following description of embodiments with reference to the attached drawings. The following description of embodiments is described by way of example.

### BRIEF DESCRIPTION OF THE DRAWINGS

FIG. 1A is a schematic view illustrating a method of molding an optical element according to the disclosure.

FIG. 1B is a schematic view illustrating the method of molding the optical element according to the disclosure.

FIG. 1C is a schematic view illustrating the method of molding the optical element according to the disclosure.

FIG. 1D is a schematic view illustrating the method of molding the optical element according to the disclosure.

FIG. 2A is a diagram for describing an evaluation position of the shape of the optical surface of the optical element of the disclosure.

FIG. 2B is a diagram for describing the evaluation position of the shape of the optical surface of the optical element according to the disclosure.

FIG. 2C is a diagram for describing the evaluation position of the shape of the optical surface of the optical element of the disclosure.

FIG. 3 is a graph showing a relationship between a mold release temperature and the PV value on an R1 surface in Embodiments 1 and 2.

FIG. 4 is a graph showing the relationship between the mold release temperature and the PV value on the R2 surface in Embodiments 1 and 2.

FIG. 5 is an example of an optical system including the optical element of the disclosure.

FIG. 6 is an example of a lens apparatus including the optical element of the disclosure.

FIG. 7 is an example of an image pickup apparatus including the optical element of the disclosure.

### DESCRIPTION OF THE EMBODIMENTS

### Embodiments

Hereinafter, embodiments of the disclosure will be described.

The disclosure will be described with reference to Embodiments and Comparative Examples. Note that drawings described below may be drawn to scale different from actual scales to facilitate understanding of embodiments of the disclosure. It should also be noted that the disclosure is not limited to the embodiments detailed below.

### [Molding of Optical Elements]

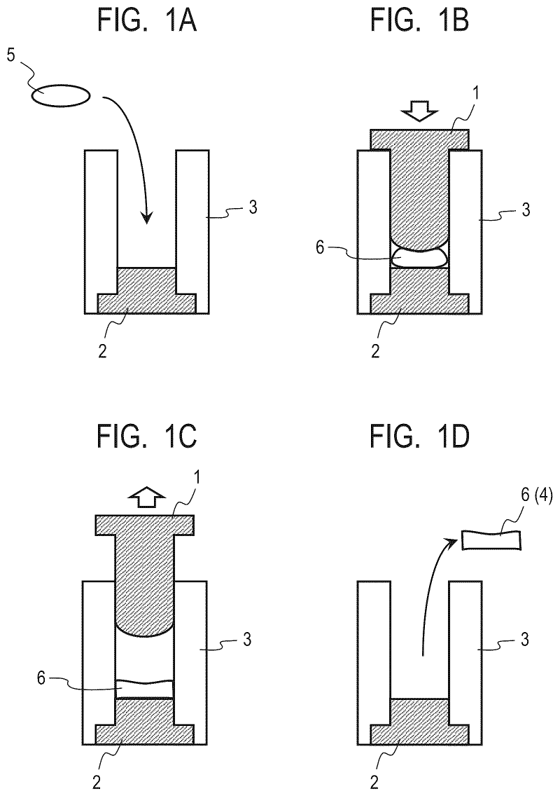

FIGS. 1A to 1D are schematic views for describing a method of molding an optical element according to the disclosure.

Each of the upper mold member 1 and the lower mold member 2 is a mold member in which a molding surface for transferring a shape of an optically effective surface of the optical element to be molded is formed with predetermined surface accuracy by predetermined grinding or polishing, and is made of, for example, a cemented carbide. The barrel mold 3 is configured to position the upper mold member 1 and the lower mold member 2 in the radial direction when the optical element is molded, and to have an inner diameter so as to form a radial end surface of the optical element. Surfaces of the molding surfaces of the upper mold member 1 and the lower mold member 2 are coated with, for example, a carbon-based film.

At the time of molding, as shown in FIG. 1A, the glass material 5 is put into the mold formed by the lower mold member 2 and the barrel mold 3, the entire mold is installed in a molding apparatus (not shown), and the entire apparatus shown in FIG. 1A is heated with nitrogen gas as an atmosphere to soften the glass material 5. Further, the upper mold member 1 is lowered along an inner surface of the barrel mold 3 (FIG. 1B), the glass material 5 is press-molded in a space formed by the upper mold member 1, the lower mold member 2, and the barrel mold 3, and after a thickness of the glass material 5 becomes a thickness of the optical element 4, the entire apparatus is cooled while the mold is closed. In one embodiment, the temperature is controlled based on the temperature of the glass material 5, but may be controlled based on the temperature based on the temperature of the upper mold member 1, the lower mold member 2, or both.

Thereafter, after cooling to a predetermined temperature, the upper mold member 1 is raised (FIG. 1C), and the upper mold member 1 or the lower mold member 2 and the molded article 6 are separated from each other (mold release). The temperature at which the upper mold member 1 is raised is referred to as a mold release temperature. The mold release temperature is set by various conditions, and a condition under which the upper mold member 1 and the molded article 6 are separated from each other while the lower mold member 2 and the molded article 6 are adhered to each other is referred to as a basic molding condition. However, when there is a temperature difference between the upper mold member 1 and the lower mold member 2, the upper mold member 1 and the molded article 6 may adhere to each other.

After cooling by passing through the mold release temperature, the molded article 6 is cooled further and taken out from the lower mold member 2 at 420° C. (FIG. 1D) to obtain the optical element 4 as the molded article 6. The molded article 6 may be subjected to an annealing treatment that does not collapse the surface shape for the purpose of removing strain. The molded article becomes an optical element through an annealing step, a centering step, and a step of forming an antireflection film or a light shielding film.

### [Shape of Optical Surface of Optical Element]

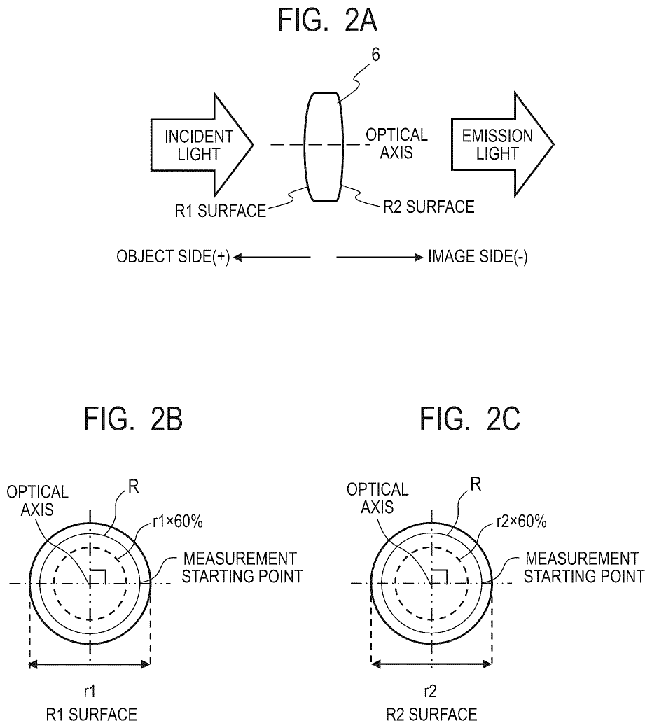

FIG. 2A is a side view of the molded article 6 with respect to the optical axis obtained in the disclosure.

Of two optical surfaces of the molded article 6, one optical surface is referred to as an R1 surface (first optical surface), and the other optical surface is referred to as an R2 surface (second optical surface). Here, for convenience, in a case where the molded article 6 is used as the optical element 4 in an optical apparatus such as a lens apparatus, a surface on an incident side is referred to as the R1 surface, and a surface on the emission side is referred to as the R2 surface, but the disclosure is not limited thereto.

The shape of the R1 surface is measured on a circumference centered on the optical axis, for example, counterclockwise by a three-dimensional measuring machine at a first radius between 100% and 60% of the optically effective diameter r1 with the optical axis as the origin (FIG. 2B) (step of acquiring f(θ)). The shape of the optical surface of the optical element is measured in such a manner that deformation toward one side in the optical axis direction is positive and deformation toward the other side is negative. Fourier transform is performed on the measurement result f(θ) with respect to the position θ in the rotation direction centered on the optical axis, and Expression (1) that approximates the position f(θ) of the surface in the optical axis direction, which is the measurement result, is obtained.

$$\begin{matrix}f ( θ ) = \sum i \{ Ai sin ( i θ + φ i ) \} & ( 0 \leq θ \leq 2 π ( rad ) )\end{matrix} \qquad ( 1 )$$

where Ai represents an amplitude and φi represents an initial phase.

Next, a corrected shape Δf(θ), which is a shape obtained by removing A1 sin(θ+φ1) which is a 1-fold symmetric component (360-degree symmetric component) and A2 sin(2θ+φ2) which is a 2-fold symmetric component (180-degree symmetric component), is acquired from an expression (2) (a step of acquiring Δf(θ)).

$$\begin{matrix}Δ f ( θ ) = \sum i \{ Ai sin ( i θ + φ i ) \} - A 1 sin ( θ + φ1 ) - A 2 sin ( 2 θ + φ2 ) & ( 0 \leq θ \leq 2 π ( rad ) )\end{matrix} \qquad ( 2 )$$

Here, the PV value is obtained from the obtained corrected shape Δf(θ) based on the difference between the maximum value and the minimum value of Δf(θ) (step of obtaining the PV value). A positive or negative sign is assigned to the PV value, and a method of assigning the sign will be described later.

Similarly to a process of acquiring the PV value for the R1 surface, which is one optical surface, a measurement process is similarly performed for the R2 surface which is the other surface from a measurement start point determined by the R1 surface (FIG. 2C). At this time, both the R1 surface and the R2 surfaces are measured on the circumference at the position of the first radius within the range of 60% or more and 100% of the optically effective diameter. In one embodiment, the measurement result at a position of a radius R where the PV value is largest in the range of 60% or more and 100% of the optically effective diameter for both the R1 surface and the R2 surface is used, but the disclosure is not limited thereto. When the measurement is performed in the same counterclockwise direction as the R1 surface, since the direction of the phase is reversed between the R1 surface and the R2 surface, it is necessary to align the directions with a start point of the measurement result of the R2 surface as an origin. In this case, the measurement results are translated and inverted to the left and right, and the measurement results are aligned with the starting point as the origin.

Next, a maximum deformation portion in each of the R1 surface and the R2 surface is obtained. Here, in this specification, the maximum deformation portion of each optical surface is defined as a position where an absolute value of a difference between the corrected shape Δf(θ) and an average height (average position in the optical axis direction) of the corrected shape Δf(θ) is the largest. The maximum deformation portion can be obtained, for example, as follows.

For example, the average height Ave of the corrected shape Δf(θ) is acquired by Expression (3) (a step of acquiring first average value, a step of acquiring second average value).

$$Ave = \frac{1}{2 π} {{\int }_{0}}^{2 π} Δ f ( θ ) d θ \qquad ( 3 )$$

In each of the R1 surface and the R2 surface, the maximum deformation portion is obtained as a position at which a maximum value is given in an absolute value D of the difference between the corrected shape Δf(θ) (0≤θ≤2π(rad)) and the average height Ave in each of the R1 surface and the R2 surface.

$$D = \vert Δ f ( θ ) - Ave \vert \qquad ( 4 )$$

In each optical surface, a magnitude (positive or negative in the optical axis direction) of the position of the maximum deformation portion in the optical axis direction with respect to the average height Ave is acquired. The PV value is denoted by a positive sign when the corrected shape Δf(θ) at the maximum deformation portion is larger than (on the object side of) the average height Ave, and is denoted by a negative sign when the corrected shape Δf(θ) is smaller than (on the image side of) the average height Ave.

The optical element of the disclosure is characterized in that the corrected shapes Δf(θ) in the maximum deformation portions of the R1 surface and the R2 surface are deformed in the same direction in the optical axis direction with respect to the average height Ave. In other words, assuming that one side in the optical axis direction is positive, the sign, relative to the first average value of Δf(θ) on the R1 surface, of Δf(θ) which shows the largest difference from the first average value is the same as the sign, relative to the second average value of Δf(θ) on the R2 surface, of Δf(θ) which shows the largest difference from the second average value. That is, the optical element of the disclosure is characterized in that the PV values of the R1 surface and the R2 surface have the same sign.

In the optical element of the disclosure, the following inequality is satisfied,

$$0 \leq \vert θ1 - θ2 \vert \leq 10 \qquad ( 5 )$$

where θ1 (degrees) represents a position of the maximum deformation portion of the R1 surface in the rotation direction about the optical axis and θ2 (degrees) represents a position of the maximum deformation portion of the R2 surface in the rotation direction about the optical axis.

In the cooling process at the time of manufacturing the optical element, the upper mold is raised at a mold release temperature (approximately in the vicinity of the glass transition temperature Tg) during cooling of the molded article, and the upper mold and the molded article are separated from each other (mold release). As the mold is released, unevenness is generated on both the surface transferred by the upper mold and the surface transferred by the lower mold. The unevenness in the optical axis direction at a certain radial position about the optical axis of each molding surface tends to increase as the mold release temperature increases.

In the mold releasing process during the production of the optical element, a case where the glass molded article strongly adheres to the upper mold (hereinafter referred to as “upper adhesion”) or a case where the glass molded article strongly adheres to the lower mold (hereinafter referred to as “lower adhesion”) occurs. Since the behavior of the molded article (optical surface) at the time of the mold release is different between the molded article formed through the upper adhesion and that through the lower adhesion in the mold release process, unevenness (deformation) is generated on the optical surface of the optical element as the molded article, and the deformation direction is affected.

For example, in a case of the lower adhesion, at the time of the mold release, a part of the surface molded by the lower mold is released earlier than the other part of the same surface to weaken the close contact with the mold, and the surface part fixed to the lower mold is pulled more than the other surface part and becomes convex in the direction of the lower mold, and a positional difference occurs in the amount of deformation in the surface in the solidification process. The deformation also affects the surface formed by the upper mold, and the corresponding portion of the surface formed by the upper mold is pulled toward the lower mold and becomes a concave.

For example, in a case where the upper adhesion occurs in a process of forming a convex aspherical lens having an approximate radius of curvature of a lower mold smaller than that of the upper mold, when a surface formed by the upper mold is an upper surface and a surface formed by the lower mold is a lower surface, deformation regions convex toward the upper mold are formed at positions of the upper and lower surfaces substantially parallel to the optical axis.

Similarly, in a case of the upper adhesion, at the time of the mold release, a part of the surface molded by the upper mold is released earlier than the other part of the same surface to weaken the close contact with the mold, and the surface part fixed to the upper mold is pulled more than the other surface part and becomes convex in the direction of the upper mold, and a positional difference occurs in the amount of deformation in the surface in the solidification process. The deformation also affects the surface formed by the lower mold, particularly in the direction of pressure removal, and the corresponding portion of the surface formed by the lower mold is pulled toward the upper mold and becomes a concave.

For example, in a case where the upper adhesion occurs in the process of forming a convex aspherical lens (having an approximate radius of curvature of the lower mold smaller than that of the upper mold), when a surface formed by the upper mold is an upper surface and a surface formed by the lower mold is a lower surface, deformation regions convex toward the upper mold direction are formed at positions of the upper and lower surfaces substantially parallel to the optical axis.

The optical element of the disclosure includes a region where the PV value satisfies the following inequality,

$$50 nm \leq \vert PV \vert \leq 1000 nm \qquad ( 6 )$$

where PV represents the PV value which is the difference between the maximum value and the minimum value of the corrected shape Δf(θ) at the radius R of 60% or more and 100% or less of the optically effective diameter about the optical axis. Here, as described above, the corrected shape Δf(θ) is obtained by removing the 1-fold symmetric component and the 2-fold symmetric component about the optical axis from the position f(θ) in the optical axis direction at the radius R of 60% or more and 100% or less of the optically effective diameter about the optical axis.

The optical element of the disclosure is characterized in that since the magnitude (absolute value) of the PV value of each optical surface is 1000 nm or smaller, the influence of scattering and reflection on deterioration of imaging performance is small.

Further, in the optical element of the disclosure, the region satisfying the inequality (6) is a region in a range of 90 degrees about the optical axis. Further, the optical surfaces of the optical element satisfying the inequality (6) are both surfaces (the R1 surface and the R2 surface) facing each other in the optical axis direction.

As described above, the optical element of the disclosure includes an optical surface having a concave-convex shape, depending on manufacturing conditions, within an optically effective diameter. Therefore, by previously grasping and storing a relationship between the manufacturing conditions such as the release temperature and the PV value, the direction of deformation due to the upper adhesion or lower adhesion, and the like, even when the optical elements of lots manufactured under different manufacturing conditions coexist, it is possible to identify the optical element by measuring the lens shape, for example, to identify the manufacturing lot, and to track and manage the manufacturing history of the lens (step of identifying the optical element). For example, it is possible to discriminate lots having different lens manufacturing conditions such as a mold release temperature, and to discriminate lots having different mold release histories from the orientation of the concave and convex shape. That is, in the optical element of the disclosure, the manufacturing conditions can be identified and tracked, and in particular, manufacturing lots having different thermal histories and release histories can be identified and tracked.

### Embodiment 1

The optical element 4 according to Embodiment 1 is formed using a glass material A (glass transition temperature Tg=500° C., refractive index nd=1.58313) as the glass material 5. The optical element 4 as the molded article 6 has an optically effective diameter of 25.8 mm, and is an aspherical biconcave lens in which an R1 surface (object side surface) is formed by an upper mold and an R2 surface (image side surface) is formed by a lower mold. The following inequality is satisfied,

$$CR 1 < CR 2$$

where CR1 and CR2 represent the approximate curvatures of the R1 surface and the R2 surface of the optical element 4, respectively.

In the present embodiment, in the above-described molding method of the optical element, the mold release temperature is 505° C. (molding condition 1A), and a temperature at which the molded article 6 is taken out from the lower mold member 2 is 420° C. In the optical element 4 of Embodiment 1, the corrected shapes Δf(θ) in the maximum deformation portions in both the R1 surface and the R2 surface are in the minus direction (image side) relative to the average height Ave, and are thus in the same direction.

In addition, the positions θ1 and θ2 in the rotation direction about the optical axis of the maximum deformation portion of the R1 surface and the maximum deformation portion of the R2 surface are located within 10 degrees from each other. In other words, the straight line connecting the maximum deformation portion of the R1 surface and the maximum deformation portion of the R2 surface is substantially parallel to the optical axis.

The PV value of the R1 surface is −53 nm, the PV value of the R2 surface is-56 nm, and the maximum deformation portions of the R1 surface and the R2 surface are deformed to have a convex shape in the same direction (image side) in the optical axis direction relative to the average height Avec.

Similarly, when molding is performed at a mold release temperature of 515° C. (molding condition 1B) and at a mold release temperature of 525° C. (molding condition 1C), the deformation direction of the maximum deformation portions in both of the R1 surface and the R2 surface are deformed to be convex in the minus direction (image side) in the optical axis direction relative to the average height Ave. In the optical element formed under the molding conditions 1B and IC, the positions of the maximum deformation portion of the R1 surface and the maximum deformation portion of the R2 surface in the rotation direction about the optical axis are located within 5 degrees to each other, and the straight line connecting the maximum deformation portion of the R1 surface and the maximum deformation portion of the R2 surface is substantially parallel to the optical axis.

In the optical element 4 formed under the molding condition 1B, the PV value of the R1 surface is −256 nm, and the PV value of the R2 surface is −165 nm. In each of the R1 surface and the R2 surface, the positions of the maximum value and the minimum value of Δf(θ) at which the PV value is measured are located within a range of 90 degrees about the optical axis.

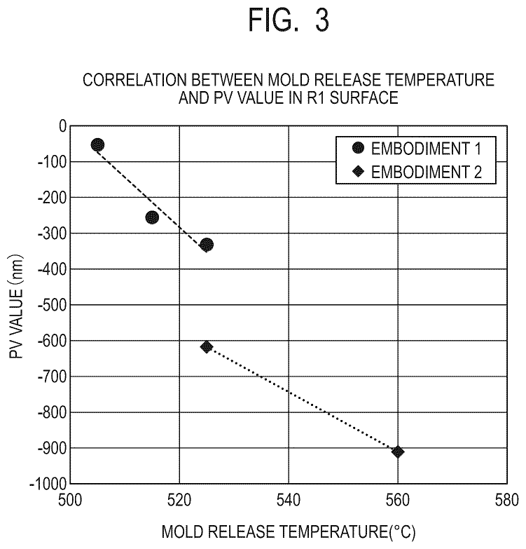

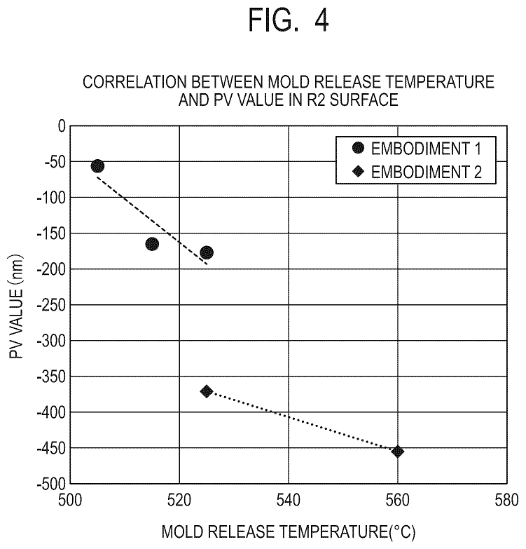

In the optical element formed under the molding condition 1C, the PV value of the R1 surface is −332 nm, and the PV value of the R2 surface is −177 nm. The relationship between the release temperature and the PV value in the optical element of this embodiment is shown in FIG. 3 for the R1 surface, and in FIG. 4 for the R2 surface. As shown in FIGS. 3 and 4, there is a correlation between the release temperature and the PV value, and the higher the release temperature is, the larger the magnitude (absolute value) of the PV value is.

In the present embodiment, since the optical element is a biconcave lens having the R2 surface with an approximate curvature larger than that of the R1 surface and is molded under the condition of the lower adhesion, the PV value appears as a negative value in all of the molding conditions 1A, 1B, and IC.

Table 1 summarizes the glass material and the lens shape of the optical element of Embodiment 1. Table 2 summarizes the molding conditions and the surface shape evaluation results of the optical element of Embodiment 1.

### (Manufacturing History Tracking)

Next, one sample S1 is arbitrarily sampled from the optical element 4 molded under the molding condition 1A, and one sample S2 is arbitrarily sampled from the optical element manufactured under the molding condition 1B. Since both the two samples S1 and S2 have no clear singularity mark, they cannot be visually distinguished after the two samples are mixed.

For each of the two samples S1 and S2, a difference in approximate radius of curvature can be visually recognized, and therefore, by comparing both surfaces, a surface having a smaller approximate radius of curvature can be identified as the R1 surface. When it is difficult to visually check, an approximate curvature or an approximate radius of curvature may be acquired by using a measuring instrument, and the R1 surface and the R2 surface may be identified.

After the R1 surface and the R2 surface of each of the sample S1 and the sample S2 are specified, the PV values of the R1 surface and the R2 surface of the two samples S1 and S2 are acquired by the above-described surface shape measurement method. As a result, the sample S1 has a PV value of the R1 surface of −341 nm and a PV value of the R2 surface of −182 nm, and the sample S2 has a PV value of the R1 surface of −56 nm and a PV value of the R2 surface of −62 nm.

From the relationship between the mold release temperature and the PV value shown in FIGS. 3 and 4, it can be determined that the sample S1 is of a lot under the molding condition 1B, and the sample S2 is of a lot under the molding condition 1A. Further, since the deformation direction of the maximum deformation portion is the minus direction in both the R1 surface and the R2 surface, it can be understood that both the sample S1 and the sample S2 were molded with the lower adhesion.

Further, the optical element 4 molded under the molding conditions 1A, 1B, and 1C according to Embodiment 1 was evaluated for the influence on MTF (Modulation Transfer Function) which is a lens performance evaluation method based on a contrast reproducibility. As a result, since the influence on the MTF is less than 10%, the deterioration of the optical imaging performance is small.

The optical element of the present embodiment has an effect of being able to identify and track the manufacturing history, and in particular, to discriminate and manage the thermal history, even if no distinct singular shape is formed in the optical element.

### Embodiment 2

The optical element 4 according to Embodiment 2 is formed using a glass material B (glass transition temperature Tg=502° C., refractive index nd=1.58313) as the glass material 5. The optical element 4 as the molded article 6 has an optically effective diameter of 38.8 mm, and is an aspherical concave lens in which an R1 surface (object side surface) is formed by an upper mold and an R2 surface (image side surface) is formed by a lower mold. The following inequality is satisfied,

$$CR 1 < CR 2$$

where CR1 and CR2 represent the approximate curvatures of the R1 surface and the R2 surface of the optical element 4, respectively.

In the present embodiment, in the method of molding the optical element 4 described above, the mold release temperature is 525° C. (molding condition 2A), and the temperature at which the molded article 6 is removed from the lower mold member 2 is 420° C. The molded article 6 is measured for both the R1 surface and the R2 surface by the surface shape measuring method described above, and the shape and the PV value of each surface are obtained. In the optical element 4 of Embodiment 2, the corrected shape Δf(θ) in the maximum deformation portion is in the minus direction (image side) relative to the average height Ave in both the R1 surface and the R2 surface, and is thus in the same direction.

In addition, the positions θ1 and θ2 in the rotation direction about the optical axis of each of the maximum deformation portion of the R1 surface and the maximum deformation portion of the R2 surface are located within 10 degrees from each other. In other words, the straight line connecting the maximum deformation portion of the R1 surface and the maximum deformation portion of the R2 surface is substantially parallel to the optical axis.

The PV value of the R1 surface is −618 nm, the PV value of the R2 surface is-371 nm, and the maximum deformation portions of both the R1 surface and the R2 surface are deformed to be convex in the same direction (image side) in the optical axis direction relative to the average height Ave. In each of the R1 surface and the R2 surface, the positions of the maximum value and the minimum value of Δf(θ) at which the PV value is measured are located within a range of 90 degrees about the optical axis.

Similarly, when molding is performed at a mold release temperature of 560° C. (molding condition 2B), the deformation direction of the maximum deformation portion is deformed to have a convex shape in the minus direction (image side) in the optical axis direction in both the R1 surface and the R2 surface relative to the average height Ave. In the optical element formed under the molding condition 2B, the positions of the maximum deformation portion of the R1 surface and the maximum deformation portion of the R2 surface in the rotation direction about the optical axis are located within 10 degrees, and the straight line connecting the maximum deformation portion of the R1 surface and the maximum deformation portion of the R2 surface is substantially parallel to the optical axis.

The PV value of the optical element 4 formed under the molding condition 1B is −911 nm for the R1 surface and −455 nm for the R2 surface. In each of the R1 surface and the R2 surface, the positions of the maximum value and the minimum value of Δf(θ) at which the PV value is measured are located within a range of 90 degrees about the optical axis.

The relationship between the release temperature and the PV value in the optical element of this embodiment is shown in FIG. 3 for the R1 surface, and in FIG. 4 for the R2 surface. As shown in FIGS. 3 and 4, there is a correlation between the release temperature and the PV value, and the higher the release temperature is, the larger the magnitude (absolute value) of the PV value is.

In the present embodiment, since the optical element is a biconcave lens having the R2 surface with an approximate curvature larger than that of the R1 surface, and is molded under the condition of the lower adhesion, the PV value appears as a negative value in both of the molding conditions 2A and 2B.

Table 1 summarizes the glass material and the lens shape of the optical element according to Embodiment 2. Table 2 summarizes the molding conditions and the surface shape evaluation results of the optical element according to Embodiment 2.

### (Manufacturing History Tracking)

In the same manner as the manufacturing history tracking of Embodiment 1, one sample S3 is arbitrarily sampled from the optical element 4 molded under the molding condition 2A, and one sample S4 is arbitrarily sampled from the optical element 4 molded under the molding condition 1B. Since both two samples S3 and S4 have no clear singularity mark, they cannot be visually identified after the two samples are mixed.

For each of the two samples S3 and S4, a difference in approximate radius of curvature can be visually recognized, and therefore, by comparing both surfaces with each other, a surface having a smaller approximate radius of curvature can be identified as the R1 surface. When it is difficult to visually check, an approximate curvature or an approximate radius of curvature may be acquired by using a measuring instrument, and the R1 surface and the R2 surface may be identified.

After the R1 surface and the R2 surface of each of the sample S3 and the sample S4 are specified, the PV values of the R1 surface and the R2 surface of the two samples S3 and S4 are acquired by the above-described surface shape measurement method. As a result, the PV value of the sample S3 is −602 nm for the R1 surface and −382 nm for the R2 surface, and the PV value of the sample S4 was −906 nm for the R1 surface and −451 nm for the R2 surface. Note that, in each of the samples S3 and S4, the positions of the maximum value and the minimum value of Δf(θ) at which the PV value was measured in each of the R1 surface and the R2 surface are located within a range of 90 degrees about the optical axis.

From the relationship between the release temperature and the PV value shown in FIGS. 3 and 4, it can be understood that the sample S3 is of a lot of the molding condition 2A and the sample S4 is of a lot of the molding condition 2B. Further, since the deformation direction of the maximum deformation portion is the minus direction of both the R1 surface and the R2 surface, both the sample S3 and the sample S4 were molded with the lower adhesion.

Further, the optical element 4 molded under the molding conditions 2A and 2B according to Embodiment 2 was evaluated for the influence on MTF which is a lens performance evaluation method based on a contrast reproducibility. As a result, since the influence on the MTF is less than 10%, it is found that the deterioration of the optical imaging performance is small.

The optical element according to the present embodiment has an effect of being able to specify and manage the manufacturing history even if a clear singular shape is not formed in the optical element.

### Embodiment 3

The optical element 4 according to Embodiment 3 is formed using a glass material C (glass transition temperature Tg=691° C., refractive index nd=1.80400) as the glass material 5. The optical element 4 as the molded article 6 has an optically effective diameter of 40.1 mm, and is an aspherical biconvex lens in which an R2 surface is formed by an upper mold and an R1 surface is formed by a lower mold. The following inequality is satisfied,

$$CR 1 > CR 2$$

where CR1 and CR2 represent the approximate curvatures of the R1 surface and the R2 surface of the optical element 4, respectively.

In the present embodiment, in the method of molding the optical element 4 described above, the mold release temperature is 674° C., and the temperature at which the molded article 6 is removed from the lower mold member 2 is 420° C. When the temperature of the upper mold member 1 is 10° C. higher than that of the lower mold member 2 at the time of mold release (molding condition 3A), the lower adhesion occurs where the lower mold member 2 and the molded article 6 adhere to each other. On the other hand, when there is no temperature difference (e.g., the temperature difference being 3° C. or less) between the upper mold member 1 and the lower mold member 2 at the time of mold release (molding condition 3B), the upper adhesion occurs where the upper mold member 1 and the molded article 6 adhere to each other.

Both the R1 surface and the R2 surface of the molded article 6 are measured with the surface shape measuring method described above, and the shape and the PV value of each surface are obtained.

In the optical element 4 molded under the molding condition 3A, the corrected shape Δf(θ) in the maximum deformation portion is in the positive direction (object side) in both the R1 surface and the R2 surface relative to the average height Ave.

In the optical element 4 molded under the molding condition 3B, the corrected shape Δf(θ) in the maximum deformation portion is in the minus direction (image side) in both the R1 surface and the R2 surface relative to the average height Ave.

In addition, the positions θ1 and θ2 in the rotation direction about the optical axis of each of the maximum deformation portion of the R1 surface and the maximum deformation portion of the R2 surface are located within 10 degrees from each other. In other words, the straight line connecting the maximum deformation portion of the R1 surface and the maximum deformation portion of the R2 surface is substantially parallel to the optical axis.

The PV value of the optical element 4 formed under the molding condition 3A is 80 nm for the R1 surface and 60 nm for the R2 surface. The PV value of the optical element 4 formed under the molding condition 3B is −60 nm for the R1 surface and −52 nm for the R2 surface. Note that, in both molding conditions 3A and 3B, the positions of the maximum value and the minimum value of Δf(θ) at which the PV value was measured on each of the R1 surface and the R2 surface are located within a range of 90 degrees about the optical axis.

Table 1 summarizes the glass material and the lens shape of the optical element according to Embodiment 3. Table 2 summarizes the molding conditions and the surface shape evaluation results of the optical element of according to Embodiment 3.

### (Manufacturing History Tracking)

In the same manner as in the production history tracking according to Embodiment 1, one sample S5 is arbitrarily sampled from a lot of the optical element 4 molded under the molding condition 3A which causes the lower adhesion, and one sample S6 is arbitrarily sampled from the lot of the optical element 4 molded under the molding condition 3B which causes the upper adhesion. Since both two samples S5 and S6 have no clear singularity mark, they cannot be visually identified after the two samples are mixed.

For each of the two samples S5 and S6, a difference in approximate radius of curvature can be visually recognized, and therefore, by comparing both surfaces with each other, a surface having a smaller approximate radius of curvature can be identified as the R2 surface. When it is difficult to visually check, an approximate curvature or an approximate radius of curvature may be acquired by using a measuring instrument, and the R1 surface and the R2 surface may be distinguished from each other.

After the R1 surface and the R2 surface of the sample S5 and the sample S6 are specified, the PV values of the R1 surface and the R2 surface of the sample S5 and the sample S6 are obtained by the above-described surface shape measurement method. As a result, the PV value of the sample S5 was 82 nm for the R1 surface and 65 nm for the R2 surface, and the PV value of the sample S6 was −62 nm for the R1 surface and −54 nm for the R2 surface.

From this, in the sample S5, since the deformation directions of the maximum deformation portions of the R1 surface and the R2 surface are plus directions, it can be specified that the sample S5 is of a lot of the molding condition 3A with the lower adhesion condition. Further, in the sample S6, since the deformation directions of the maximum deformation portions of the R1 surface and the R2 surface are negative directions, it can be specified that the sample S6 is of a lot of the molding condition 3B with the upper adhesion condition.

Furthermore, it can be seen that the optical element 4 formed under the molding conditions 3A and 3B according to Embodiment 3 has a PV value of 50 nm or more and 1000 nm or less, and the evaluation of the influence on the MTF shows the influence being less than 10%, so that the deterioration of the optical imaging performance is small.

In the optical element of the present embodiment, even if the optical element does not have a clear singular shape, it is possible to discriminate and manage manufacturing lots having different thermal histories and mold release histories by grasping the relationship between the PV value and the manufacturing condition in advance.

Table 1 shows glass materials and lens shapes of the optical elements according to Embodiments 1 to 3.

TABLE 1

| | | | optically | |
|---|---|---|---|---|
| | | | effective | |
| | glass | | diameter | approximate |
| embodiment | material | lens shape | (mm) | curvature |
| 1 | I | concave lens | 25.8 | C_{R1} < C_{R2} |
| 2 | II | concave lens | 38.8 | C_{R1} < C_{R2} |
| 3 | III | convex lens | 40.1 | C_{R1} > C_{R2} |

Table 2 shows the molding conditions and the surface shape evaluation results of the optical elements according to Embodiments 1 to 3.

TABLE 2

| | | mold | suface | | deformation | | | | |
|---|---|---|---|---|---|---|---|---|---|
| | | release | molded | | direction | | PV value (nm) | | effect |
| | forming | temp. | by upper | lower/upper | R1 | R2 | R1 | R2 | on |
| embodiment | condition | (deg.) | mold | adhesion | surface | surface | surface | surface | MTF |
| 1 | 1A | 505 | R1 | lower | − | − | −53 | −56 | <10% |
| | | | surface | adhesion | | | | | |
| | 1B | 515 | | lower | − | − | −256 | −165 | <10% |
| | | | | adhesion | | | | | |
| | 1C | 525 | | lower | − | − | −332 | −177 | <10% |
| | | | | adhesion | | | | | |
| 2 | 2A | 525 | R1 | lower | − | − | −618 | −371 | <10% |
| | | | surface | adhesion | | | | | |
| | 2B | 560 | | lower | − | − | −911 | −455 | <10% |
| | | | | adhesion | | | | | |
| 3 | 3A | 674 | R2 | lower | + | + | 80 | 60 | <10% |
| | | | surface | adhesion | | | | | |
| | 3B | 674 | | upper | − | − | −60 | −52 | <10% |
| | | | | adhesion | | | | | |

### Other Embodiments

### (Optical System)

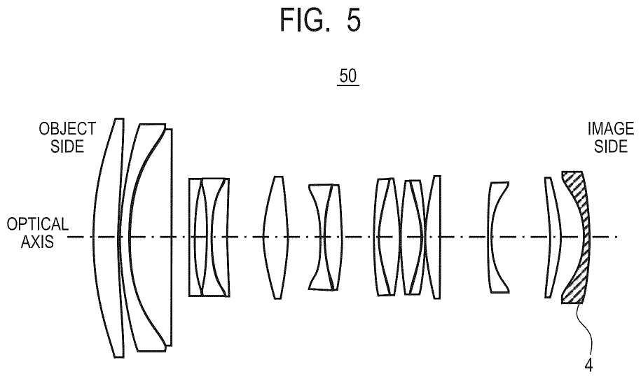

FIG. 5 shows an example of an optical system 50 including the optical element 4 of the disclosure. The optical system 50 can enjoy the effect of the disclosure of including the optical element 4 capable of easily managing the manufacturing conditions and tracking the manufacturing history while suppressing the deterioration of the optical imaging performance.

### (Lens Apparatus)

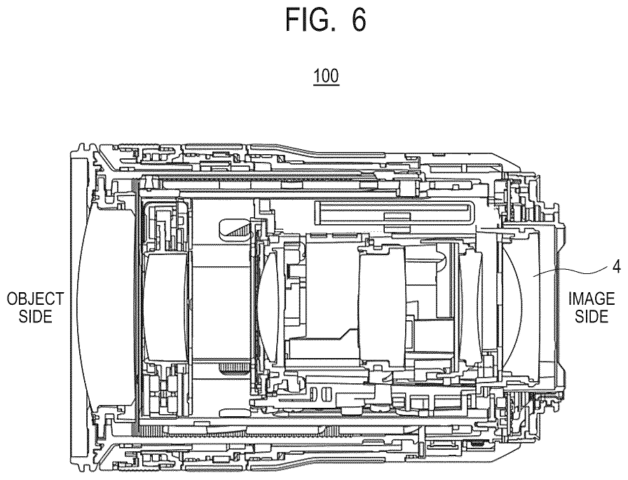

FIG. 6 shows an example of a lens apparatus 100 including an optical system including the optical element 4 of the disclosure. The lens apparatus 100 can enjoy the effect of the disclosure of including the optical element 4 capable of easily managing manufacturing conditions and tracking manufacturing history while suppressing deterioration of optical imaging performance.

### (Image Pickup Apparatus)

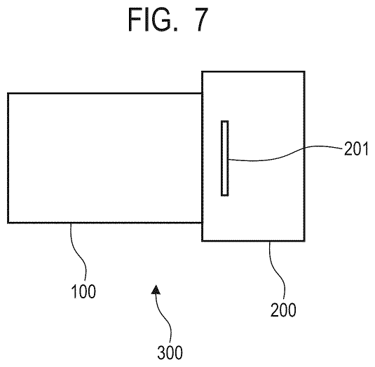

FIG. 7 is a schematic view of an image pickup apparatus 300 including the lens apparatus 100 including the optical element of the disclosure. The image pickup apparatus 300 having the effects of the disclosure can be realized by the lens apparatus 100 including the optical element of the disclosure and the camera apparatus 200 including the image pickup element 201 that receives (captures) an image formed by the lens apparatus 100.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-134902, filed Aug. 13, 2024, which is hereby incorporated by reference herein in its entirety.

What is claimed is:

1. An optical element comprising a region that satisfies a following inequality,
50 nm≤|PV|≤1000 nm
where PV represents a PV value which is a difference between a maximum value and a minimum value of Δf(θ) which is obtained by removing a 1-fold symmetric component and a 2-fold symmetric component about an optical axis from f(θ), where f(θ) represents a position of an optical surface in an optical axis direction on a circumference at a first radius of 60% or more and 100% or less of an optically effective diameter with respect to a position θ in a rotation direction about the optical axis.

2. The optical element according to claim 1, wherein the Δf(θ) is obtained by performing Fourier transformation on the f(θ) and removing the 1-fold symmetric component and the 2-fold symmetric component from the f(θ) subjected to the Fourier transformation.

3. The optical element according to claim 2, wherein the optical surfaces are a first optical surface and a second optical surface facing each other in the optical axis direction.

4. The optical element according to claim 3, wherein, when one side in the optical axis direction is defined as positive, a sign of the Δf(θ), relative to a first average value of the Δf(θ), having a largest difference from the first average value on the first optical surface is the same as a sign of the Δf(θ), relative to a second average value of the Δf(θ), having a largest difference from the second average value on the second optical surface.

5. The optical element according to claim 3, wherein the following inequality is satisfied,
$$0 \leq \vert θ1 - θ2 \vert \leq 10$$
where, when one side in the optical axis direction is defined as positive, θ1 represents a position in degrees in a rotation direction about the optical axis at which a difference between the Δf(θ) and a first average value of the Δf(θ) on the first optical surface is largest and θ2 represents a position in degrees in the rotation direction about the optical axis at which a difference between the Δf(θ) and a second average value of the Δf(θ) on the second optical surface is largest.

6. The optical element according to claim 1, wherein the region is a region in a range of 90 degrees about the optical axis.

7. An apparatus comprising an optical element, wherein the optical element comprises a region that satisfies the following inequality,
$$50 nm \leq \vert PV \vert \leq 1000 nm$$
where PV represents a PV value which is a difference between a maximum value and a minimum value of Δf(θ) which is obtained by removing a 1-fold symmetric component and a 2-fold symmetric component about an optical axis from f(θ), where f(θ) represents a position of an optical surface in an optical axis direction on a circumference at a first radius of 60% or more and 100% or less of an optically effective diameter with respect to a position θ in a rotation direction about the optical axis.

8. A pickup apparatus comprising: the apparatus according to claim 7; and a pickup element configured to receive an image formed by the lens apparatus.

9. A method of identifying an optical element, comprising:
obtaining f(θ) representing a position in an optical axis direction of an optical surface of the optical element on a circumference at a position of a first radius of 60% or more and 100% or less of an optically effective diameter of the optical element with respect to a position θ in a rotation direction about the optical axis;
obtaining Δf(θ) by removing a 1-fold symmetric component and a 2-fold symmetric component about the optical axis from the f(θ); and
identifying the optical element based on the Δf(θ).

10. The method according to claim 9, wherein the identifying comprises obtaining a PV value that is a difference between a maximum value and a minimum value of the Δf(θ).

11. The method according to claim 10, wherein the identifying identifies the optical element based on the PV value with respect to two optical surfaces of the optical element and a relationship, stored in advance, between the PV value and a mold release temperature during molding of the optical element.

12. The method according to claim 11, wherein the identifying identifies the optical element based on a magnitude relationship between an approximate curvatures of the two optical surfaces of the optical element.

13. The method according to claim 9, further comprising:
obtaining a first average value of the Δf(θ) on a first optical surface of the optical element; and
obtaining a second average value of the Δf(θ) on a second optical surface of the optical element,
wherein the identifying step identifies the optical element based on a sign of the Δf(θ), relative to the first average value, having a largest difference from the first average value on the first optical surface and a sign of the Δf(θ), relative to the second average value, having a largest difference from the second average value on the second optical surface.
